(19) United States
(12) Patent Application Publication
(10) Pub. No.: US 2007/0041358 A1
(43) Pub. Date: Feb. 22, 2007

(54) Telephony system

(76) Inventor: John Wolsey Cook, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 10/573,079

(22) PCT Filed: Sep. 8, 2004
(86) PCT No.: PCT/GB04/03824

§ 371 Date: Mar. 23, 2006

(30) Foreign Application Priority Data
Sep. 30, 2003 (GB) 0322894.7

(51) Int. Cl. H04L 12/66

(52) U.S. Cl. 370/352

(57) ABSTRACT

A system for and a method of providing a telephony service is disclosed. Supplying power to a node in a telecommunications network from a subscriber's premises conflicts with the plain old telephone service POTS. Until the advent of the present invention it was thought that supplying power in this way required either an additional electrical transmission wire or providing voice support within a digital subscriber line (DSL) service. In the proposed system telephony control signals, as supplied by an exchange (103) on to a first section (107) of an electrical transmission line, are converted into modified downstream control signals having a different frequency to electrical power, which is supplied onto a second section (109) of the electrical transmission line, and electrical equipment in a node that interconnects the first and second sections can draw electrical power supplied by the power supply without affecting the operation of a telephone (101).

This invention relates to a system for and method of providing a telephony service.

Digital subscriber line (DSL) technology is close to the limits of what can be achieved in terms of transmission over the access network (the last link in a telecommunications network between the subscriber's premises and the exchange consisting predominantly of twisted-pair copper wires). To achieve an increase in the achievable data rates requires that the electronics for providing the DSL technology be installed closer to the subscriber, for example, in a network node at the cross connection point (a node used to distribute a larger feeder cable containing a number of transmission lines into a plurality of smaller distribution cables each containing a smaller number of transmission lines), which is sometimes called the ‘cabinet’, or at a distribution point (a node used to distribute several distribution cables into individual subscriber transmission lines), which is sometimes called the ‘pole’.

The deployment of such network node electronics is dependent upon the provision of power to the electronics at a low cost and with a high reliability.

One solution is to requisition a power supply from a public utility, e.g. by tapping into street lighting circuits but this can be very expensive. Alternatively, power can be fed directly to the network node from the exchange over a twisted-pair copper wire. However, network nodes are usually too far from the exchange to make this a viable option. This is because the resistance of the wire-pairs (which increases with distance from the exchange) is often much higher than the DC input impedance of the network node electronics. This results in more power being dropped across the wire-pairs and therefore less power being available to the network node electronics.

It has also been suggested (see “Powering Active Wodes in Active Loops”, Fisher, S., International Conference on Communications—Conference Record, vol. 2, 23 Jun. 1991, pages 929-935) to supply power to the network node electronics from subscribers' premises. However, this conflicts with the plain old telephone service (POTS) where DC power and telephony must be supported over a single twisted-pair copper wire and a number of telephony signalling states are each represented by a DC voltage or line condition. Until the advent of the present invention, it was thought that supplying power in this way either required:
a spare twisted-pair copper wire (for the DC power feed from the subscriber to the network node electronics) or;
providing voice support within DSL, i.e. voice over DSL or VoDSL.

A spare twisted-pair copper wire is often not available and is expensive to provide. Moreover, if VoDSL is used and the power to the subscriber premises fails causing the DSL service to fail, the subscriber will be left without a voice telephony service and this is undesirable.

According to a first aspect of the present invention there is provided a system for providing a telephony service between an exchange and a telephone said system comprising:

an exchange;

a telephone;

an electrical transmission line connecting said exchange and said telephone;

a node inserted in said electrical transmission line, said node defining a first section of said electrical transmission line extending from said exchange to said node, and a second section of said electrical transmission line extending from said node to said telephone, said exchange, in use, supplying telephony control signals and voiceband signals on to said first section;

a power supply arranged in operation to supply electrical power on to said second section;

a signal converter arranged in operation to convert telephony control signals supplied by said exchange into modified downstream control signals having a frequency that is different to the frequency of said electrical power;

said node comprising electrical equipment arranged in operation to draw electrical power supplied by said power supply from said second section.

By converting telephony control signals, supplied by an exchange on to a first section of an electrical transmission line, into modified downstream control signals having a different frequency to electrical power, which is supplied onto a second section of the electrical transmission line, electrical equipment in a node that interconnects the first and second sections can draw electrical power supplied by the power supply without affecting the operation of the telephone.

The term downstream is intended to describe a direction from the exchange to the telephone. Conversely, the term upstream is intended to describe a direction from the telephone to the exchange.

In other embodiments, the system further comprises a subscriber unit inserted in said second section, said subscriber unit defining a network subsection thereof extending from said node to said subscriber unit, and a subscriber subsection thereof extending from said subscriber unit to said telephone, said subscriber unit comprising a further signal converter arranged in operation to convert said modified control signals into telephony control signals as supplied by said exchange. Thus the telephone requires no modification.

Preferably, said subscriber unit further comprises said power supply means. Thus components at the subscriber's premises are contained within the subscriber unit.

In preferred embodiments, said node further comprises a bypass transmission line bypassing said signal converter and said subscriber unit further comprises a bypass transmission line bypassing said further signal converter. Thus a telephony service can be provided between the telephone and the exchange even when the power to a subscriber's premises fails.

In other embodiments, said node further comprises filter means arranged in operation to allow said voiceband signals to pass across said node with minimal attenuation but substantially attenuate all other signals. Thus non-voiceband signals originating from said exchange are isolated from non-voiceband signals originating elsewhere in the system. According to a second aspect of the present invention there is provided a node in a telecommunications network, said node interconnecting first and second sections of an electrical transmission line, said electrical transmission line connecting an exchange in said first section to a telephone in said second section and arranged in operation to carry telephony control signals and voiceband signals supplied on to said first section, said node comprising:

electrical equipment arranged in operation to draw electrical power supplied on to said second section;

a signal converter arranged in operation to convert telephony control signals supplied by said exchange into modified downstream control signals having a frequency that is different to the frequency of said electrical power and modified upstream control signals into telephony control signals.

According to a third aspect of the present invention there is provided a subscriber unit in a telecommunications network, said subscriber unit interconnecting first and second sections of an electrical transmission line, said electrical transmission line connecting an exchange in said first section to a telephone in said second section and arranged in operation to carry telephony control signals and voiceband signals supplied on to said first section, said subscriber unit comprising:

a power supply arranged in operation to supply electrical power on to said second section;

a signal converter arranged in operation to convert telephony control signals supplied by said telephone into modified upstream control signals having a frequency that is different to the frequency of said electrical power and modified downstream control signals into telephony control signals.

According to a fourth aspect of the present invention there is provided a method of providing a telephony service between an exchange and a telephone, wherein said exchange and said telephone are connected by an electrical transmission line having a node inserted therein, said node defining a first section of said electrical transmission line extending from said exchange to said node, and a second section of said electrical transmission line extending from said node to said telephone, said method comprising the steps:

(i) supplying telephony control signals and voiceband signals from said exchange on to said first section;

(ii) supplying electrical power on to said second section;

(iii) converting telephony control signals supplied by said exchange into modified downstream control signals having a frequency that is different to the frequency of said electrical power;

(iv) operating electrical equipment in said node to draw electrical power from said second section.

Embodiments of the present invention will now be described, by way of example only, with reference to the accompanying drawings, wherein like reference numbers refer to like parts, and in which:

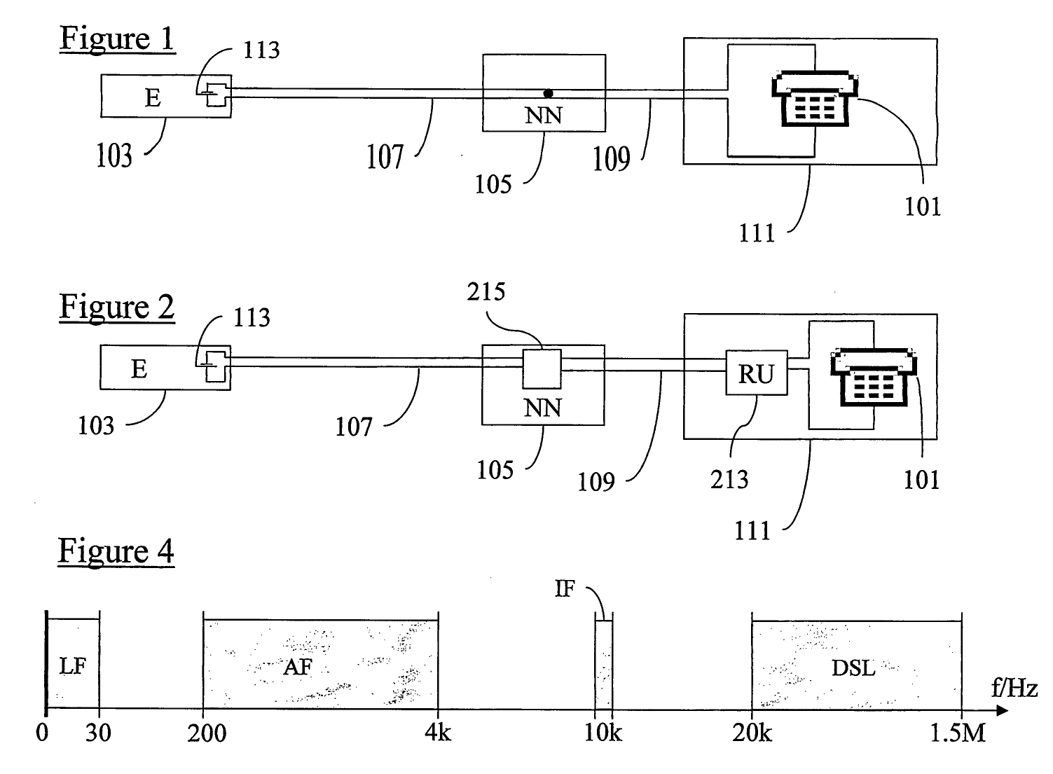

FIG. 1 shows a schematic of part of a public switched telephone network (PSTN) according to the prior art;

FIG. 2 shows a schematic of part of a PSTN according to an embodiment of the present invention;

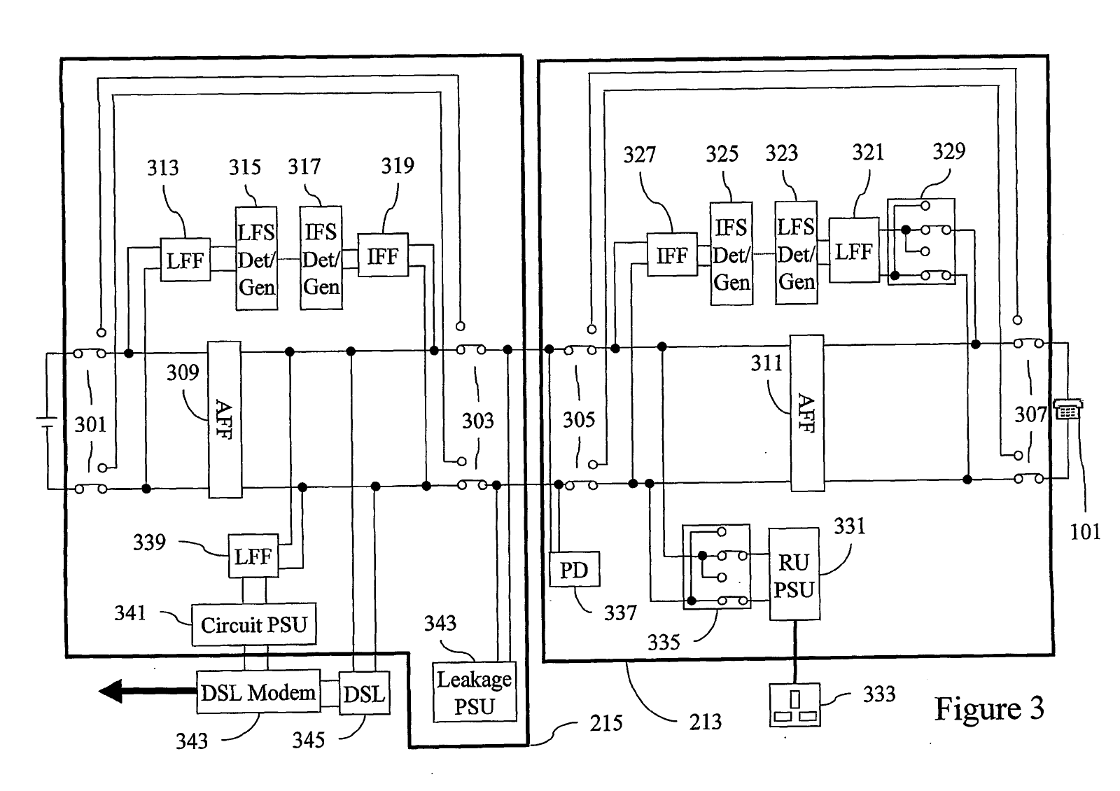

FIG. 3 shows a block diagram depicting a network node circuit and a remote unit;

FIG. 4 shows a frequency spectrum of signals flowing in the PSTN of FIG. 2;

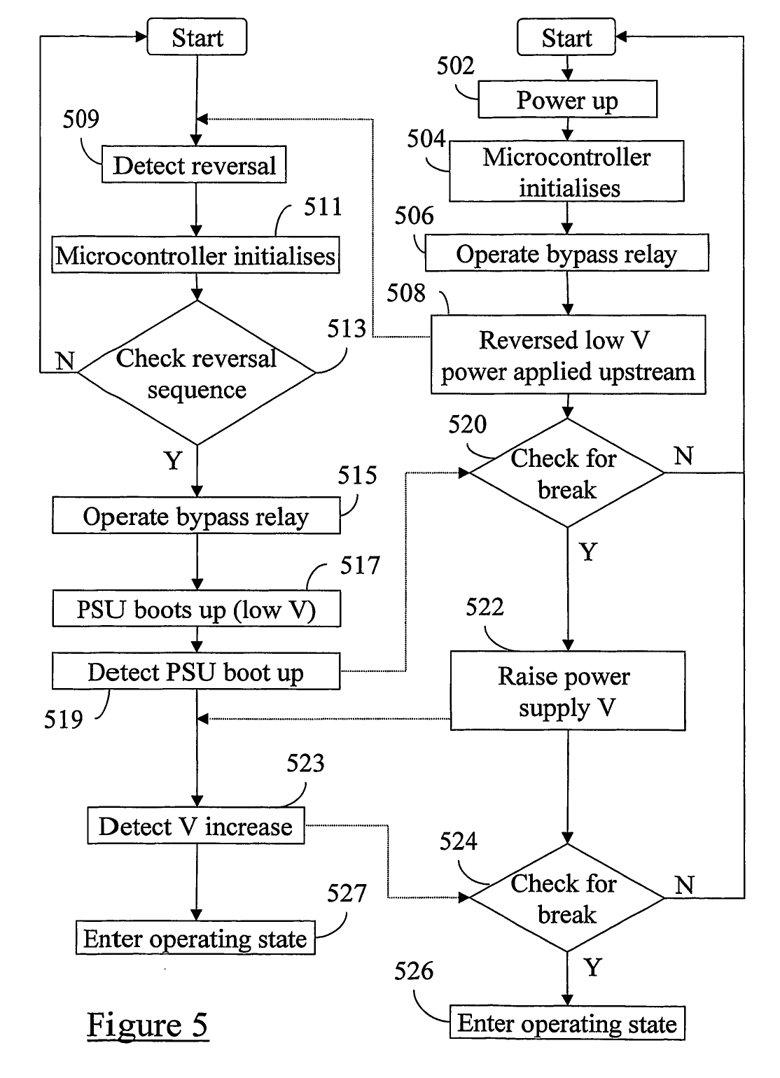

FIG. 5 shows a flow diagram of the power-up sequence for the circuit and remote unit of FIG. 3;

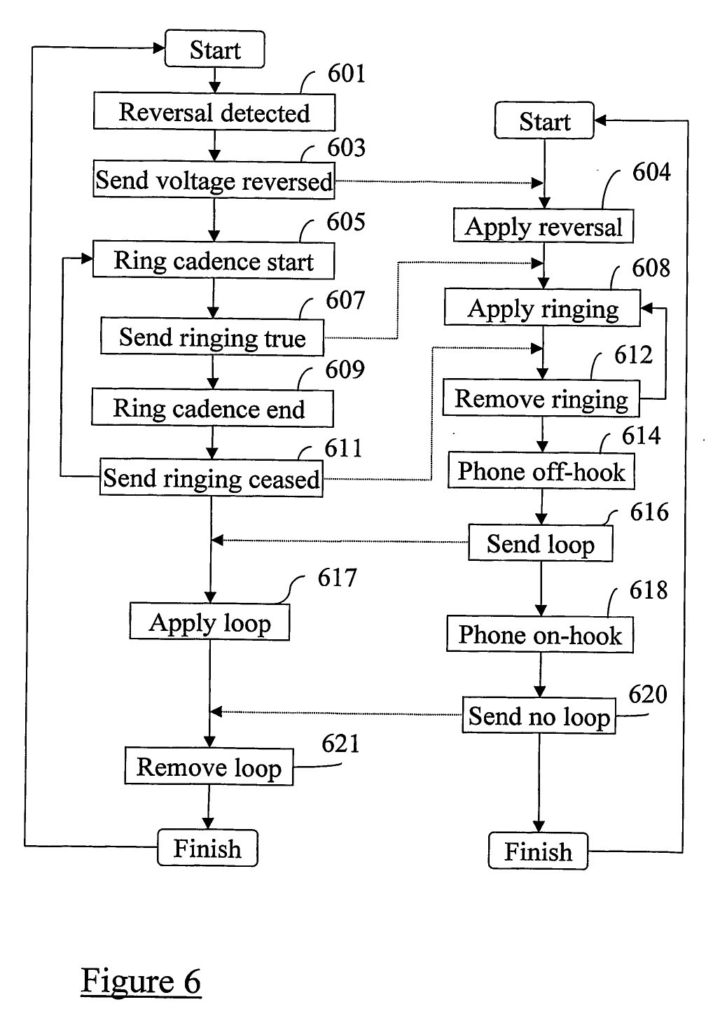

FIG. 6 shows a flow diagram of the incoming call sequence for the circuit and remote unit of FIG. 3;

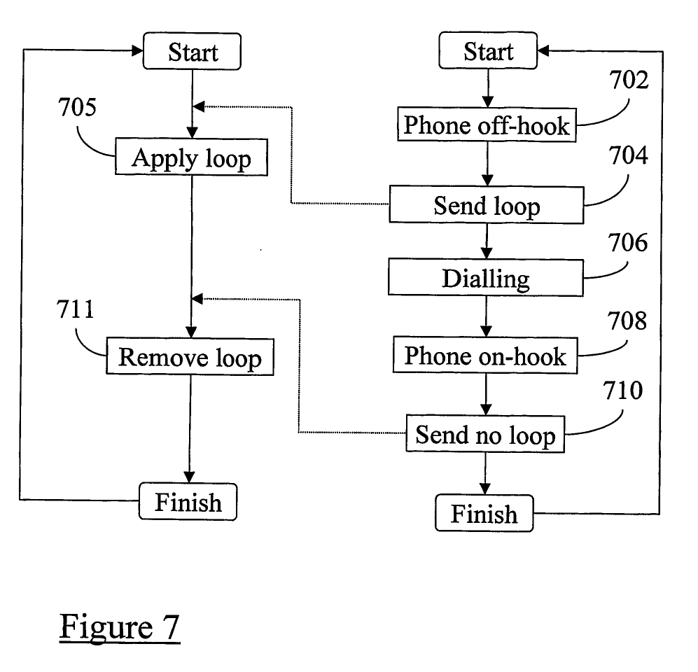

FIG. 7 shows a flow diagram of the outgoing call sequence for the circuit and remote unit of FIG. 3.

FIG. 1 is a schematic of part of a public switched telephone network (PSTN) according to the prior art in which a subscriber's telephone 101 within a subscriber's premises 111, is connected to a telephone exchange 103 via a transmission line. The transmission line comprises two sections, an exchange section 107 and a distribution section 109, that are interconnected by a network node 105. The network node 105 might be a distribution point (DP) often referred to as a ‘pole’. However, it could also be a primary cross connection point (PCCP), often referred to as a ‘cabinet’, or a secondary cross connection point (SCCP), often referred to as a ‘pillar’.

In this prior art arrangement, the exchange section 107 of the transmission line connects the exchange 103 to the exchange side of network node 105 whilst the distribution section 109 of the transmission line connects the distribution side of network node 105 to the telephone 101. The exchange and distribution sections are directly connected inside the network node 105. The distribution section 109 of the transmission line is often shorter than the exchange section 107. Often, the distribution section 109 is between 10 m and 100 m whilst the exchange section 107 is between 2 km and 3 km. However the distribution section 109 could be up to 1.5 km whilst the exchange section 107 could be up to 5 km.

Each section of the transmission line comprises a twisted pair of copper wires. It is to be noted that where network node 105 comprises a DP, the exchange section 107 of the transmission line will comprise a cable containing many twisted pairs of copper wires whilst the distribution section will comprise a single twisted pair copper wire. For simplicity, however, only one of the twisted pairs of copper wires in the exchange section 107 is shown in FIG. 1. A 48 V battery 113 located in exchange 103 is applied across the exchange section 107.

Taking the telephone “off hook” closes a switch inside telephone 101, which is connected across the distribution section 109. This completes a circuit around which current is driven by battery 113. This is often referred to as “applying loop” to the line. Furthermore, when current flows in this circuit it is often referred to as the loop current and the “off-hook” condition is often referred to as the looped condition. Conversely, placing the telephone “on hook” opens the switch resulting in an open circuit. This is often referred to as “removing loop” from the line.

When telephone 101 is “on-hook”, there is an open circuit and only a very small leakage current (typically 50 μA) flows in the transmission line. When telephone 201 is taken “off-hook”, a loop current flows in the transmission line. The magnitude of the loop current depends on the resistance of the transmission line (which in turn depends on the length of the transmission line) and the DC impedance of the electronics in exchange 103 and telephone 101. Typical values for these quantities are 600Ω, 400Ω and 200Ω respectively resulting in a typical value for the loop current of 40 mA. Therefore, in the “off-hook” condition, the voltage drop across telephone 101 is typically 8 V with the remaining voltage drop (40 V) occurring over the transmission line and exchange electronics.

Signalling is the action of communication between the telephone 101 and the exchange 103 for the control and supervision, setting up and clearing down of telephone calls. Direct signalling is used wherein a number of telephony signalling states are each represented by a DC voltage or line condition. These DC voltages and line conditions are applied directly on to the wires which carry the audio signals. For example, in response to a ‘no loop’ condition at the telephone (i.e. when the telephone is on-hook) the battery in the exchange applies a normal feed (i.e. −48 V) to the transmission line. When the telephone is being called, the exchange applies a reverse feed to the line (i.e. +48 V) as well as applying a 75 V AC, 25 Hz ringing signal. In response to a subscriber taking the telephone off-hook (e.g. in order to make an outgoing telephone call), loop is applied to the line which is detected by the exchange which responds by applying a dial tone voltage signal in addition to a normal feed.

FIG. 2 is a schematic of part of a public switched telephone network (PSTN) according to preferred embodiments of the present invention. In preferred embodiments, an existing PSTN as described above in relation to FIG. 1 is used, save for the addition of a remote unit 213 and a circuit 215. Telephone 101 is connected to network node 105 via remote unit 213 situated inside the premises 111. In some embodiments, telephone 101 and/or remote unit 213 may be external to premises 111. The remote unit 213 and its operation will be described below. A circuit 215 within network node 105 is connected between the exchange section 107 and the distribution section 109. Circuit 215 and its operation will also be described below.

In both the prior art and a first embodiment of the present invention, a DSL modem is installed within network node 105. The DSL modem receives signals via a fibre-optic link supplied to the network node 105, converts these signals to electrical signals and applies them to the distribution section 109 of the transmission line. It is, of course, necessary to provide to the DSL modem to enable it to operate. However, drawing power from the battery 113 in exchange 103 is found to reduce the power supplied to telephone 101 to the extent that it ceases to operate properly. However, in the present embodiment remote unit 213 is connected to a local power feed (e.g. mains power) operable to provide DC power to a remote unit power supply unit. The remote unit power supply unit is operable to supply current to telephone 101 to enable it to function properly. Moreover, since a local power feed is used to provide power to telephone 101, it is no longer necessary to supply DC power on to the distribution section 109 of the transmission line. The remote unit power supply unit can instead feed power on to the distribution section 109 for transmission towards circuit 215 within network node 105, which power can be used to power the service load. Although a DSL modem is powered in the present embodiment, those skilled in the art will realise that the present invention can be used to power other service loads, such as a wireless network access point.

A filter in circuit 215 is used to prevent the exchange DC voltage from passing from the exchange section 107 of the transmission line to the distribution section 109 and also to prevent the remote unit DC voltage from passing from the distribution section 109 of the transmission line to the exchange section 107. The filter allows audio signals to pass from the exchange section 107 to the distribution section 109 (and vice versa) and therefore audio signals can be communicated between exchange 103 and telephone 101. It will be remembered that a number of different telephony signalling states are each represented by a DC voltage or line condition. Since DC voltages are blocked by circuit 215 in network node 105, telephony signalling is terminated by circuit 215 and communicated to and from the remote unit 213 via an alternative signalling protocol that will be described below. The DC signalling state is subsequently regenerated by circuit 215 or remote unit 113 for onwards transmission to exchange 103 or telephone 101 respectively.

FIG. 3 is a block diagram depicting circuit 215 inside network node 105 and also remote unit 213. Circuit 215 and remote unit 213 each contain three circuit branches: a bypass branch, an audio branch and a signalling branch.

When circuit 215 and remote unit 213 are operating in a bypass mode of operation, signals flowing between exchange 103 and telephone 101 will flow through the bypass branch. Circuit 215 and remote unit 213 operate in the bypass mode when no DC voltage is being supplied on to the distribution section 109 of the transmission line. Such a scenario would arise, for example, if the remote unit power supply unit 331 was not switched on or ‘plugged-in’ to the mains 333 or if there was a mains power failure at the subscriber's premises. In this case, network node 105 would directly connect the exchange and distribution sections of the transmission line as in the prior art.

When the remote unit power supply unit 331 (which will be described below) is supplying DC voltage on to the distribution section 109 of the transmission line, circuit 215 and remote unit 213 operate in a no-bypass mode of operation. In the no-bypass mode, signals flowing between exchange 103 and telephone 101 flow through the audio and signalling branches of circuit 215 and remote unit 213. The no-bypass mode and the audio and signalling branches will be described below.

In order to switch between the bypass and no-bypass modes of operation, four relay operated, two-way switches are provided, two in circuit 215 and two in remote unit 213. Each switch has two switching positions, a bypass position and a no-bypass position. When operating in the bypass mode, the switches are in the bypass position and when operating in the no-bypass mode, the switches are in the no-bypass position. In FIG. 3, the switches are shown in the no-bypass position. Switches 301/303 are connected to and controlled by a circuit microcontroller (not shown). Similarly, switches 305/307 are connected to and controlled by a remote unit microcontroller (not shown).

The audio branches of circuit 215 and remote unit 213 each contain an audio frequency filter 309/311. The audio frequency filters 309/311 ensure that only audio signals pass through circuit 215 and remote unit 213. In preferred embodiments, the audio frequency filters 309/311 comprise bandpass filters that allow audio signals in a frequency passband (e.g. from 200 Hz to 4 kHz) to pass through with minimal attenuation. (It will be realised that audible telephony information tones [e.g. dial tones, ‘line busy’ tone, ‘line ringing’ tone] will also pass through the filter with minimal attenuation.) All other signals (e.g. DC signals and signals having a frequency above the upper limit of the frequency passband) will be substantially attenuated. In this way the exchange section DC signals are separated from the distribution section DC signals. Thus DC signals that have been supplied onto the distribution section 109 of the transmission line by the remote unit power supply unit are not transmitted towards exchange 103.

The signalling branch in circuit 215 comprises a low frequency filter 313, low frequency signal detector/generator 315, intermediate frequency signal detector/generator 317 and intermediate frequency filter 319. Low frequency signal detector/generator 315 and intermediate frequency signal detector/generator 317 are connected to and controlled by the circuit microcontroller.

Low frequency filter 313 only allows signals with a frequency below a threshold frequency to pass through with minimal attenuation. In preferred embodiments this threshold frequency is set to just greater than 25 Hz so that a 25 Hz ringing signal will pass through the filter with minimal attenuation. DC signals and low frequency ringing signals that are blocked by audio frequency filter 309 pass through low frequency filter 313.

The low frequency signal detector/generator 315 is operable to determine the sense of the line feed from the exchange, i.e. it determines whether the DC signal received from the exchange has a voltage of +48 V or −48 V. It can therefore detect a reversal of the line feed applied at the exchange. Exchange 103 applies such a reversal to indicate a ringing signal (in addition to adding a 75 V RMS signal at 25 Hz to the transmission line). The low frequency signal detector/generator 315 is also operable to apply a loop current to exchange 103 when telephone 101 is taken off-hook. This acts as a signalling function. Intermediate frequency signal detector/generator 317 is operable to detect and generate signals at a frequency that is out of band to telephony service signals and also out of band to any DSL service signals also present on the transmission line. The intermediate frequency might therefore be 10 kHz. In the present embodiment, the signals that are detected/generated by intermediate frequency signal detector/generator 317 are signalling messages in the form of Hamming-coded short messages sent using binary tone bursts. Different signalling messages (which will be described below) are used to represent different telephony signalling states, i.e. different DC voltages and/or line conditions. Intermediate frequency filter 319 comprises a narrowband filter that only allows signals in a narrow frequency passband (e.g. 9.9 kHz-10.1 kHz) to pass through with minimal attenuation. All other signals (e.g. audio signals and DC signals) will be substantially attenuated.

The signalling branch in remote unit 213 comprises a low frequency filter 321, low frequency signal detector/generator 323, intermediate frequency signal detector/generator 325, intermediate frequency filter 327 and a reversing switch 329. Low frequency signal detector/generator 321, intermediate frequency signal detector/generator 327 and reversing switch 329 are connected to and controlled by the remote unit microcontroller. Intermediate frequency filter 327 is similar to intermediate frequency filter 319. Like its counterpart in circuit 215, intermediate frequency signal detector/generator 325 is operable detect and generate intermediate frequency signalling messages.

Low frequency filter 321 is similar to low frequency filter 313. DC signals that are blocked by audio frequency filter 311 pass through low frequency filter 321.

Low frequency signal detector/generator 323 is operable to supply a DC loop current to telephone 101 when it is taken off-hook. This loop current mimics the loop current that was supplied in prior art systems by exchange 103 (typically 40 mA). Low frequency signal detector/generator 323 detects the presence or absence of a loop (i.e. when the telephone is off-hook or on-hook) by observing the loop current flow. Low frequency signal detector/generator 323 is also operable to generate a ringing signal and transmit it to telephone 101.

Reversing switch 329 is used to mimic line feed reversals from exchange 103 as relayed from circuit 215.

The signalling messages that are generated and detected by intermediate frequency signal detector/generator 319 and intermediate frequency signal detector/generator 327 will now be individually explained.

Loop/No-loop

The loop and no-loop messages are generated by intermediate frequency signal detector/generator 325 to indicate that telephone 101 is off-hook or on-hook. When telephone 101 is taken off-hook, low frequency signal detector/generator 323 detects an increase in loop current and informs the remote unit microcontroller. The remote unit microcontroller then causes intermediate frequency signal detector/generator 325 to generate and transmit a loop message. This message passes through intermediate frequency signalling filters 327/319 and is detected by intermediate frequency signal detector/generator 317, which can communicate the arrival of the loop message to the circuit microcontroller. Similarly, when telephone 101 is placed on-hook, low frequency signal detector/generator 323 detects a decrease in loop current and informs the remote unit microcontroller. The remote unit microcontroller then causes intermediate frequency signal detector/generator 325 to generate and send a no-loop message. This message passes through intermediate frequency signalling filters 327/319 and is detected by intermediate frequency signal detector/generator 317, which can communicate the arrival of the no-loop message to the circuit microcontroller. The circuit microcontroller can then cause the low frequency signal detector/generator 313 to apply a loop current to exchange 103 or remove such a loop current.

Voltage Reversed

The voltage reversed message is generated and sent by detected by intermediate frequency signal detector/generator 317 to indicate the sense of the line feed from the exchange 103, i.e. whether the DC signal received from the exchange has a voltage of +48 V or −48 V. Low frequency signal detector/generator 313 is operable to detect a reversal of the line feed applied at exchange 103 and to communicate this fact to the circuit microcontroller. The circuit microcontroller then causes intermediate frequency signal detector/generator 317 to generate and send a voltage reversed message. This message passes through intermediate frequency filters 319/327 and is detected by intermediate frequency signal detector/generator 325, which can communicate the arrival of the voltage reversed message to the remote unit microcontroller. The remote unit microcontroller can then operate reversing switch 329 in order to mimic the reversal.

Ringing True/Ringing Ceased

The ringing true/ringing ceased messages are generated and sent by intermediate frequency signal detector/generator 317 to indicate the presence of a ringing signal that has been applied to the transmission line at the exchange 103. Low frequency signal detector/generator 313 is operable to detect the presence of a ringing signal on the transmission line that has been applied at exchange 103 and to communicate this fact to the circuit microcontroller. The circuit microcontroller then causes intermediate frequency signal detector/generator 317 to generate and send a ringing true message. This message passes through intermediate frequency filters 319/327 and is detected by intermediate frequency signal detector/generator 325, which can communicate the arrival of the ringing true message to the remote unit microcontroller. The remote unit microcontroller can then operate low frequency signal detector/generator 323 to generate a ringing signal and transmit it to telephone 1 01. Similarly, intermediate frequency signal detector/generator 317 is operable to detect the removal of the ringing signal on the transmission line and to communicate this fact to the circuit microcontroller. The circuit microcontroller then causes intermediate frequency signal detector/generator 317 to generate and send a ringing ceased message. This message passes through intermediate frequency filters 319/327 and is detected by intermediate frequency signal detector/generator 325, which can communicate the arrival of the ringing ceased message to the remote unit microcontroller. The remote unit microcontroller can then operate low frequency signal detector/generator 323 to stop generating the ringing signal.

In addition to the remote unit components described above, within remote unit 213 there is additionally a remote unit power supply unit 331, a reversing switch 335 and a polarity detector 337.

In operation, remote unit power supply unit PSU 331 feeds DC power on to the distribution section 109 of the transmission line. In the present embodiment, PSU 331 can supply power in a low voltage mode or a normal voltage mode. When operating in a low voltage mode, PSU 331 supplies DC power at 48 V. When operating in normal voltage mode, PSU 331 supplies DC power at 90 V. The remote unit microcontroller instructs PSU 331 as to which mode to operate in. Preferably, PSU 331 is powered from a mains power supply 333. The two PSU modes of operation will be described below. PSU 331 is also used to supply DC power to the remote unit microcontroller, intermediate frequency signal detector/generator 325, low frequency signal detector/generator 323 and switches 305/307.

PSS 331 feeds DC on to the distribution section 109 of the transmission line via reversing switch 335. Reversing switch 335 is used to ensure that the polarity of the DC power feed being supplied onto the distribution section 109 of the transmission line by PSU 331 is reversed with respect to any DC power feed being received from exchange 103. (There will be a DC power feed from the exchange when the remote unit 213 is not operating and all signals are being transmitted via the bypass branches.) This is useful in relation to the remote unit 213 start up procedure, which will be described below. A polarity detector 337 (installed on the exchange side of switch 305) detects the polarity of the line feed received from the exchange (i.e. whether it is +48 V or −48 V) and communicates this information to the remote unit microcontroller. The remote unit microcontroller uses this information when operating reversing switch 335 to ensure that the polarity of the DC power feed being supplied onto the distribution section 109 of the transmission line by PSU 331 is reversed with respect to the line feed received from the exchange 103.

In addition to the components of circuit 215 described above, circuit 215 additionally comprises a further low frequency filter 339, a circuit power supply unit 341 and a leakage power supply unit 343.

Low frequency filter 339 only allows signals with a frequency below a threshold frequency to pass through with minimal attenuation. In preferred embodiments the low frequency filter 339 acts as DC-only filter. Thus DC signals that have been supplied onto the distribution section 109 of the transmission line by PSU 331 (and which are blocked by audio frequency filter 309 and intermediate frequency filter 319) pass through low frequency filter 339 towards a circuit power supply unit (PSU) 341.

Circuit PSU 341 receives DC power via low frequency filter 339. Circuit PSU 341 has multiple outputs and, in the present embodiment, is used to supply DC power to a DSL modem 343 also situated in the network node 105. Other hardware that needs power to operate and which can be situated in network node 105 will be apparent to somebody skilled in the art. Circuit PSU 341 is also used to supply DC power to the circuit microcontroller, low frequency signal detector/generator 315, intermediate frequency signal detector/generator and switches 301/303.

In preferred embodiments, circuit PSU 341 operates in either a low voltage mode or a normal voltage mode. When operating in low voltage mode, circuit PSU 341 receives and supplies DC power at 48 V. When operating in normal voltage mode, circuit PSU 341 receives and supplies DC power at 90 V. Circuit PSU 341 is able to communicate its mode of operation to the circuit microcontroller. These two circuit PSU modes of operation will be described below. The circuit microcontroller is also able to detect when circuit PSU 341 stops supplying power (i.e. when circuit PSU 341 stops receiving power from the remote unit PSU 331).

There will be a short period of time after the remote unit 213 becomes operational before circuit PSU 341 becomes operational. Since circuit PSU 341 provides circuit microcontroller and switches 301/303 with operational power it will not be possible to operate switches 301/303 in this time period and hence it is not possible to stop signals flowing via the circuit bypass branch. It is therefore useful to install leakage PSU 343 on the distribution side of switch 303. Leakage PSU 343 uses the leakage current that flows along the transmission line via the circuit bypass branch (when the telephone is “on-hook”) to store enough charge to operate switches 301/303 after the remote unit 213 becomes operational but before PSU 341 is functional.

With reference to the flowcharts in FIGS. 5-7, the operation of the combined system of exchange 103, circuit 215, remote unit 213 and telephone 101 will now be described in respect of four examples. These examples are:

1. Power-up sequence for circuit 215 and remote unit 213;

2. Power-down sequence for circuit 215 and remote unit 213;

3. Operational mode incoming call sequence for circuit 215 and remote unit 213;

4. Operational mode outgoing call sequence for circuit 215 and remote unit 213.

In FIGS. 5-7, odd numbered integers refer to steps carried out by circuit 215 whilst even numbered integers refer to steps carried out by remote unit 213.

Power-Up Sequence for Circuit 215 and Remote Unit 213

The remote unit 213 starts in a powered down state (i.e. in the preferred embodiment, no mains power is being supplied to REMOTE UNIT PSU 331) and in this state, switches 305/307 are in the bypass position causing all signals to flow through remote unit 213 via the bypass branch.

With the remote unit 213 starting in a powered down state, circuit 215 also starts in a powered down state but with leakage PSU 343 supplying leakage power to the circuit microcontroller. Like switches 305/307, switches 301/303 are in the bypass position causing all signals to flow through via the circuit bypass branch.

Referring to FIG. 5, mains power is applied to remote unit 213 and more specifically to remote unit PSU 331 (step 502). Then, remote unit microcontroller (which derives operational power from remote unit PSU 331) initialises itself (step 504) and it moves the switches 305/307 to the no-bypass position (step 506). Then the remote unit microcontroller communicates with polarity detector 337. The purpose of this communication is to check that there is an exchange-derived line feed present on the transmission line and to determine its polarity. On these conditions being met, the remote unit microcontroller communicates with remote unit PSU 331 and reversing switch 335 in order to apply a reversed 48 V line feed on to the distribution section 109 of the transmission line (step 508). In preferred embodiments, before supplying a steady 48 V line feed, two 100 ms interruptions to the supply are provided in the first 500 ms of supply. (This is useful in order that circuit 215 interprets the reversed power feed as the remote unit 213 ‘waking up’ and not as a ringing signal.) Once the 48 V line feed is steady, the remote unit microcontroller monitors the current flowing on the distribution section 109 of the transmission line.

Leakage PSU 343 detects the reversal applied at the remote unit 213 (step 509) and communicates this information to the circuit microcontroller causing it to initialise (step 511). Then, the circuit microcontroller checks the sequence of reversals for 500 ms to ensure that the reversals are indicative of the remote unit 213 initialisation signature (step 513). If the reversal sequence check fails then the circuit microcontroller powers down with memory not to initialise again for another 20 s even if a reversal is detected. This 20 s wait ensures that the number of times the circuit microcontroller initialises is kept to a minimum when ringing signals are present of the transmission line. If the reversal sequence check is passed then the circuit microcontroller, in conjunction with leakage PSU 343, moves switches 301/303 to the no-bypass position (step 515). The circuit microcontroller then waits for PSU 341 to become operational.

The DC signals supplied onto the distribution section 109 of the transmission line by PSU 331 pass through low frequency filter 339 towards circuit PSU 341 causing circuit PSU 341 to become operational in its low power mode (step 517). Then, the circuit microcontroller detects circuit PSU 341 has become operational (step 519) and in response operates switches 301/303 in order to break the current flow. In order to do this, switches 301/303 are moved to the no-bypass position for 100 ms and then back to the bypass position.

As was mentioned above, the remote unit microcontroller monitors the current flowing on the transmission line (step 520). If no break in the current flowing occurs within 2 s, the remote unit microcontroller operates switches 305/307 moving them to the bypass position and the power up sequence begins again after a delay (e.g. 30 s). If, however, the remote unit microcontroller does detect a break in the current flowing on the transmission line (caused by the circuit microcontroller) then it times the break. If the break is timed to last 100 ms±20% then the remote unit mnicrocontroller causes remote unit PSU 331 to increase the line feed to 90 V (step 522). The remote unit microcontroller then continues to monitor the current flowing on the transmission line. If the break is not timed to last 100 ms±20% then the remote unit microcontroller operates switches 305/307 moving them to the bypass position and the power up sequence begins again after a delay (e.g. 30 s).

The circuit microcontroller detects the increase in line feed to 90 V (step 523) and in response operates switches 301/303 in order to break the current flow. Again, in order to do this, switches 301/303 are moved to the no-bypass position for 100 ms and then back to the bypass position. The circuit microcontroller then waits 500 ms to check whether or not the 90 V line feed is stable.

As was mentioned above, the remote unit microcontroller monitors the current flowing on the transmission line (step 524). If no break in the current flow occurs within 2 s, the remote unit microcontroller moves switches 305/307 to the bypass position and the power up sequence begins again after a delay (e.g. 30 s). If, however, the remote unit microcontroller does detect a break in current flow on the transmission line (caused by the circuit microcontroller) then it times the break. If the break is timed to last 100 ms±20% then the remote unit microcontroller causes remote unit PSU 331 to continue the line feed at 90 and the remote unit microcontroller enters its operating state and waits for incoming or outgoing calls (step 526). If the break is not timed to last 100 ms±20% then the remote unit microcontroller moves switches 305/307 to the bypass position and the power up sequence begins again after a delay (e.g. 30s).

The circuit microcontroller detects that the 90 V line feed is stable and in response it also enters its operating state (step 527) where it waits for incoming or outgoing calls. On instruction from the circuit microcontroller, circuit PSU 341 also starts supplying power to the service load 325 at this time.

Power-Down Sequence for Circuit 215 and Remote Unit 213

The remote unit 213 starts in its operating state with remote unit PSU 331 supplying power at 90 V DC onto the distribution section 109 of the transmission line. Similarly, circuit 215 starts in its operating state with circuit PSU 341 receiving the power fed by remote unit PSU 331 in order to supply power to the DSL modem 343.

As was mentioned above, remote unit PSU 331 is preferably powered from the mains 333. If there was an interruption in the mains power supply to remote unit PSU 331 (e.g. if there was a power failure or if the remote unit 213 was switched off/unplugged by a subscriber) then remote unit PSU 331 would immediately cease supplying power onto the distribution section 109 of the transmission line and switches 305/307 would move back to the bypass position resulting in the remote unit 213 entering its powered down state.

In response, circuit PSU 341 communicates with the circuit microcontroller to inform it of the loss of input power. The circuit microcontroller then moves switches 301/303 to the bypass position and enters its powered down state with leakage PSU 323 supplying leakage power to the circuit microcontroller.

Operational Mode Incoming Call Sequence for Circuit 215 and Remote Unit 213

The remote unit 213 starts in its operating state with remote unit PSU 331 supplying power at 90V DC onto the d-side section of the transmission line. Similarly, circuit 215 starts in its operating state with circuit PSU 341 receiving the power supplied by remote unit PSU 331 in order to supply power to DSL modem 343.

Signals representing an incoming call are received at exchange 103 for routing to telephone 101. In response, exchange 103 applies a reversal to the DC line feed that it transmits towards circuit 215 inside network node 105. The reversal is detected in circuit 215 by low frequency signal detector/generator 315 (step 601), which communicates its knowledge of the reversal to the circuit microcontroller. Then, the circuit microcontroller causes intermediate frequency signal detector/generator 317 to send a voltage reversed message (step 603) to remote unit 213. This message passes through intermediate frequency filters 319/327 and is received by intermediate frequency signal detector/generator 325 which can communicate the arrival of the voltage reversed message to the remote unit microcontroller. The remote unit microcontroller can then operate reversing switch 329 in order to mimic the reversal (step 604).

Next, exchange 103 applies a ringing signal onto the transmission line. The start of the ring cadence is detected in circuit 215 by low frequency signal detector/generator 315 (step 605). Low frequency signal detector/generator 315 communicates that the ring cadence has started to the circuit microcontroller, which causes intermediate frequency signal detector/generator 317 to send a ringing true message to remote unit 213 (step 607). This message passes through intermediate frequency filters 319/327 and is received by intermediate frequency signal detector/generator 325 which can communicate the arrival of the ringing true message to the remote unit microcontroller. The remote unit microcontroller can then operate low frequency signal detector/generator 323 to generate a ringing signal and transmit it to telephone 101 (step 608). The end of the ring cadence is detected in circuit 215 by low frequency signal detector/generator 315 (step 609). Low frequency signal detector/generator 315 communicates that the ring cadence has ended to the circuit microcontroller, which causes intermediate frequency signal detector/generator 317 to send a ringing ceased message to remote unit 213 (step 611). This message passes through intermediate frequency filters 319/327 and is received by intermediate frequency signal detector/generator 325 which can communicate the arrival of the ringing ceased message to the remote unit microcontroller. On instruction from the remote unit microcontroller, low frequency signal detector/generator 323 then ceases to generate a ringing signal (step 612). Until such a time as a subscriber takes telephone 101 off-hook in order to accept the incoming call, low frequency signal detector/generator 323 will continue to apply and remove ringing in response to the ringing true/ceased messages received from intermediate frequency signal detector/generator 317.

When telephone 101 is taken off-hook (step 614), low frequency signal detector/generator 323 detects an increase in loop current and informs the remote unit microcontroller. At the same time low frequency signal detector/generator 323 stops generating a ringing signal. The remote unit microcontroller then causes intermediate frequency signal detector/generator 325 to send a loop message (step 616). This message passes through intermediate frequency filters 327/319 and is received by intermediate frequency signal detector/generator 317 which can communicate the arrival of the loop message to the circuit microcontroller. In response, the circuit microcontroller communicates with low frequency signal detector/generator 315 in order to apply loop to exchange 103 (step 617). At this stage the call is in progress and continues until such a time as telephone 101 is replaced on-hook.

When telephone 101 is placed on-hook (step 618), low frequency signal detector/generator 323 detects a decrease in loop current and informs the remote unit microcontroller. The remote unit microcontroller then causes intermediate frequency signal detector/generator 325 to send a no loop message (step 620). This message passes through intermediate frequency filters 327/319 and is received by intermediate frequency signal detector/generator 317 which can communicate the arrival of the loop message to the circuit microcontroller. In response, the circuit microcontroller communicates with low frequency signal detector/generator 315 in order to apply loop to exchange 103 (step 621). Both the remote unit 213 and the network node 105 then enter their operational state and once again wait for incoming or outgoing calls.

Operational Mode Outgoing Call Sequence for Circuit 215 and Remote Unit 213

The remote unit 213 starts in its operating state with remote unit PSU 331 supplying power at 90 V DC onto the d-side section of the transmission line. Similarly, circuit 215 starts in its operating state with circuit PSU 341 receiving the power supplied by remote unit PSU 331 in order to supply power to DSL modem 343.

The outgoing call sequence is initiated by telephone 101 being taken off-hook (step 702). When telephone 101 is taken off-hook, low frequency signal detector/generator 323 detects an increase in loop current and informs the remote unit microcontroller. The remote unit microcontroller then causes intermediate frequency signal detector/generator 325 to send a loop message (step 704). This message passes through intermediate frequency filters 327/319 and is received by intermediate frequency signal detector/generator 317 which can communicate the arrival of the loop message to the circuit microcontroller. In response, the circuit microcontroller communicates with low frequency signal detector/generator 315 in order to apply loop to exchange 103 (step 705).

At this time, a telephone number is dialed on telephone 101 (step 706). In preferred embodiments this results in telephone 101 transmitting a series of DTMF (dual tone multiple frequency) tones passing through audio frequency filters 311/309 to exchange 103. However, in alternative embodiments this results in a series of loop-disconnect dial pulses which are detected by low frequency signal detector/generator 323 and mapped into multiple loop/no-loop messages for transmission to the network node 105 via intermediate frequency signal detector/generator 325, intermediate frequency signal detector/generator 317 and then on to exchange 103 via low frequency signal detector/generator 315. At this stage the call is in progress and continues until such a time as telephone 101 is replaced on-hook.

When telephone 101 is placed on-hook (step 708), low frequency signal detector/generator 323 detects a decrease in loop current and informs the remote unit microcontroller. The remote unit microcontroller then causes intermediate frequency signal detector/generator 325 to send a no loop message (step 710). This message passes through intermediate frequency filters 327/319 and is received by intermediate frequency signal detector/generator 317 which can communicate the arrival of the loop message to the circuit microcontroller. In response, the circuit microcontroller communicates with low frequency signal detector/generator 315 in order to apply loop to exchange 103 (step 711). Both the remote unit 213 and the network node 105 then enter their operational state and once again wait for incoming or outgoing calls.

Telephone 101 receives the power it needs to operate via remote unit 213 and more specifically, remote unit PSU 331 and low frequency signal detector/generator 323. This removes the need to supply DC power to telephone 101 from exchange 103. Remote unit PSU 331 is therefore arranged in operation to feed DC power onto the distribution section 109 of the transmission line towards circuit 215 inside network node 105. This DC power supplied by the remote unit 213 can then be used to supply DC power to electronic hardware situated in network node 105. Telephony signalling is terminated inside by circuit 215 and remote unit 213 and communicated between circuit 215 and remote unit 213 via an alternative signalling protocol. In this way, upstream power feeding is enabled over the same electrical transmission path as is used to carry the telephony service.

It will be apparent from the foregoing description that many modifications or variations may be made to the above described embodiment without departing from the invention. Such modifications and variations include:

In the above described embodiment, the combination of the low frequency filter 313, low frequency signal detector/generator 315, the circuit microcontroller, intermediate frequency signal detector/generator 317 and intermediate frequency filter 319 converted DC control signals for onward transmission to the remote unit 213. In alternative embodiments, this conversion process could be carried out inside the exchange 103. This would result in less equipment having to be installed in network node 105 thus reducing the installation costs. Furthermore, since there is less equipment in network node 105, more of the power supplied by circuit PSU 341 can be used to supply a service load. It should be noted that in such an embodiment, audio frequency filters 309/311 would comprise high pass filters rather than bandpass filters. In fact, high pass filters could be used for audio filters 309/409 in any of the above described embodiments.

In the above described embodiment, both circuit 215 and remote unit 213 contained two switches linked together by a bypass path. This embodiment is useful in situations where it is desirable to maintain a telephony service when power to remote unit 213 fails. In an alternative embodiment, however, switches 301/303, switches 305/307 and the bypass branches are omitted. In such an embodiment, when the power to remote unit 213 fails, it will not be possible to provide a telephony service since all DC signals will be blocked by audio frequency filters 309/311 and no DC signals will be able to reach telephone 101. Therefore, such an embodiment could be used in situations where it is not considered important to maintain a telephony service when the power to the remote unit 213 fails. It is worth noting that the power-up sequence of both circuit 215 and remote unit 213 (as described above in relation to FIG. 5) in such an embodiment would be simplified since there are no bypass branches to operate and there is no need to distinguish between telephony signalling and power supplied from remote unit 213. This is because before circuit 215 and remote unit 213 are operational, any DC signals received at circuit 215 from remote unit 213 must be DC power since they cannot be telephony signals. Circuit 215 would therefore power-up autonomously as soon as it had the necessary power to do so.

In another alternative embodiment, telephone 101 could include the functionality provided by remote unit 213 thereby removing the requirement to house additional equipment within the subscriber's premises 211.

1. A system for providing a telephony service between an exchange and a telephone said system comprising:
an exchange;
a telephone;
an electrical transmission line connecting said exchange and said telephone;
a node inserted in said electrical transmission line, said node defining a first section of said electrical transmission line extending from said exchange to said node, and a second section of said electrical transmission line extending from said node to said telephone, said exchange, in use, supplying telephony control signals and voiceband signals on to said first section;
a power supply arranged in operation to supply electrical power on to said second section;
a signal converter arranged in operation to convert telephony control signals supplied by said exchange into modified downstream control signals having a frequency that is different to the frequency of said electrical power;
said node comprising electrical equipment arranged in operation to draw electrical power supplied by said power supply from said second section.

2. A system according to claim 1, wherein said signal converter is further arranged in operation to convert modified upstream control signals into telephony control signals.

3. A system according to either claim 1 or claim 2, wherein said node further comprises said signal converter.

4. A system according to any of claims 1 to 3, further comprising:
a subscriber unit inserted in said second section, said subscriber unit defining a network subsection thereof extending from said node to said subscriber unit, and a subscriber subsection thereof extending from said subscriber unit to said telephone, said subscriber unit comprising a further signal converter arranged in operation to convert said modified control signals into telephony control signals as supplied by said exchange.

5. A system according to claim 4, wherein said further signal converter is further arranged in operation to convert telephony control signals supplied by said telephone into modified upstream control signals and wherein said signal converter is further arranged in operation to convert modified upstream control signals into telephony control signals as supplied by said telephone.

6. A system according to either claim 4 or claim 5, wherein said subscriber unit further comprises said power supply.

7. A system according to claim 3, wherein said node further comprises a bypass transmission line bypassing said signal converter.

8. A system according to claims 3 or 4, wherein said subscriber unit further comprises a bypass transmission line bypassing said further signal converter.

9. A system according to any of the preceding claims, wherein said node further comprises a filter arranged in operation to allow said voiceband signals to pass across said node with minimal attenuation but substantially attenuate all other signals.

10. A system according to any of the preceding claims, wherein said subscriber unit further comprises a filter arranged in operation to allow said voiceband signals to pass across said subscriber unit with minimal attenuation but substantially attenuate all other signals.

11. A system according to any of the preceding claims, wherein said modified control signals have a frequency that is different to the frequency of said voiceband signals.

12. A node in a telecommunications network, said node interconnecting first and second sections of an electrical transmission line, said electrical transmission line connecting an exchange in said first section to a telephone in said second section and arranged in operation to carry telephony control signals and voiceband signals supplied on to said first section, said node comprising:
electrical equipment arranged in operation to draw electrical power supplied on to said second section;
a signal converter arranged in operation to convert telephony control signals supplied by said exchange into modified downstream control signals having a frequency that is different to the frequency of said electrical power and modified upstream control signals into telephony control signals.

13. A subscriber unit in a telecommunications network, said subscriber unit interconnecting first and second sections of an electrical transmission line, said electrical transmission line connecting an exchange in said first section to a telephone in said second section and arranged in operation to carry telephony control signals and voiceband signals supplied on to said first section, said subscriber unit comprising:
a power supply arranged in operation to supply electrical power on to said second section;
a signal converter arranged in operation to convert telephony control signals supplied by said telephone into modified upstream control signals having a frequency that is different to the frequency of said electrical power and modified downstream control signals into telephony control signals.

14. A method of providing a telephony service between an exchange and a telephone, wherein said exchange and said telephone are connected by an electrical transmission line having a node inserted therein, said node defining a first section of said electrical transmission line extending from said exchange to said node, and a second section of said electrical transmission line extending from said node to said telephone, said method comprising the steps:
(i) supplying telephony control signals and voiceband signals from said exchange on to said first section;
(ii) supplying electrical power on to said second section;
(iii) converting telephony control signals supplied by said exchange into modified downstream control signals having a frequency that is different to the frequency of said electrical power;
(iv) operating electrical equipment in said node to draw electrical power from said second section.
